(19) United States
(12) Patent Application Publication
(10) Pub. No.: US 2025/0374078 A1
(43) Pub. Date: Dec. 4, 2025

(54) SYSTEMS AND METHODS FOR FORECASTING TIME SERIES NETWORK CAPACITY

(71) Applicant: Verizon Patent and Licensing Inc., Basking Ridge, NJ (US)

(72) Inventors: Jason A. BIRR, Lithia, FL (US); Hector Alejandro GARCIA CRESPO, N Richland Hills, TX (US); Ammara ESSA, Los Angeles, CA (US); Matthew KAPALA, North Billerica, MA (US); Timothy E. COYLE, Chicopee, MA (US); Brian A. WARD, Fort Worth, TX (US); Gene R. BUIST, Chesterfield, MO (US); Christopher SCHILLING, Hatfield, PA (US)

(73) Assignee: Verizon Patent and Licensing Inc., Basking Ridge, NJ (US)

(21) Appl. No.: 18/676,823

(22) Filed: May 29, 2024

(51) Int. Cl. H04W 24/02; H04L 41/16; H04L 43/04; H04L 43/0876; H04L 47/127; H04L 47/2441

(52) U.S. Cl. CPC H04W 24/02; H04L 41/16; H04L 43/04; H04L 43/0876; H04L 47/127; H04L 47/2441

(57) ABSTRACT

A device may receive load data identifying a load on a radio access network (RAN), and may select one or more time series forecasting models and a classification model based on seasonality metrics associated with the load data. The device may process the load data, with the one or more time series forecasting models, to forecast a capacity for the RAN, and may process the load data and the capacity, with the classification model, to determine whether the capacity exceeds a capacity threshold. The device may selectively determine that the RAN does not need an upgrade based on determining that the capacity fails to exceed the capacity threshold, or may adjust, based on determining that the capacity exceeds the capacity threshold, the capacity to generate an adjusted capacity. The device may perform one or more actions based on the adjusted capacity.

### BACKGROUND

Radio access network (RAN) capacity planning is an important task for telecommunications network providers. RAN capacity planning requires accurate and predictive insights into when a RAN will require upgrades to accommodate growing user demands.

### BRIEF DESCRIPTION OF THE DRAWINGS

FIGS. 1A-1F are diagrams of an example associated with forecasting time series network capacity.

FIGS. 2A and 2B are diagrams illustrating an example of training and using machine learning models.

FIG. 3 is a diagram of an example environment in which systems and/or methods described herein may be implemented.

FIG. 4 is a diagram of example components of one or more devices of FIG. 3.

FIG. 5 is a flowchart of an example process for forecasting time series network capacity.

### DETAILED DESCRIPTION OF EXAMPLE EMBODIMENTS

The following detailed description of example implementations refers to the accompanying drawings. The same reference numbers in different drawings may identify the same or similar elements.

At the heart of RAN capacity planning is the capability of forecasting when a RAN will exceed capacity limits of the RAN, and triggering a need for expansion or enhancement of RAN resources. One metric utilized in RAN capacity planning is a scheduler metric. The scheduler metric provides a measure of the loading of control channels and systems of a RAN, and indicates a quantity of users waiting for a RAN service. The scheduler metric may be utilized to determine whether the RAN needs an upgrade to accommodate the quantity of users. However, traditional time series forecasting techniques (e.g., utilized for RAN capacity planning) do not work very well for forecasting key performance indicators (KPIs) with non-linear behavior, such as the scheduler metric. Thus, current techniques for RAN capacity planning consume computing resources (e.g., processing resources, memory resources, communication resources, and/or the like), networking resources, and/or other resources associated with failing to accurately forecast RAN capacity for non-linear KPIs, handling poor end user experience due to failing to accurately forecast RAN capacity, failing to address service degradation in the RAN in a timely manner due to failing to accurately forecast RAN capacity, handling lost traffic due to failing to accurately forecast RAN capacity, and/or the like.

Some implementations described herein provide a forecasting system that forecasts time series network capacity. For example, the forecasting system may receive load data identifying a load on a RAN, and may select one or more time series forecasting models (e.g., one or more Prophet models) and a classification model (e.g., an XGBoost model) based on seasonality metrics associated with the load data. The forecasting system may process the load data, with the one or more time series forecasting models, to forecast a capacity for the RAN, and may process the load data and the capacity, with the classification model, to determine whether the capacity exceeds a capacity threshold. The forecasting system may selectively determine that the RAN does not need an upgrade based on determining that the capacity fails to exceed the capacity threshold, or may adjust, based on determining that the capacity exceeds the capacity threshold, the capacity to generate an adjusted capacity. The forecasting system may perform one or more actions based on the adjusted capacity.

In this way, the forecasting system forecasts time series network capacity. For example, the forecasting system may utilize advanced predictive analytics to enhance accuracy and reliability of capacity forecasting in RAN planning. Specifically, the forecasting system may forecast a time series output based on historical data for one or more capacity metrics. The forecasting system may determine a binary classification output (e.g., indicating whether a capacity threshold is expected to be exceeded) by applying a binary classification model to the time series output and additional features. To ensure the integrity of the forecasting, the forecasting system may adjust the time series output based on the binary classification outcome by applying rotational stitching in cases of discrepancies. Furthermore, the forecasting system may utilize seasonality detection techniques in historical data to identify the most significant data points for the binary classification model, and may utilize a scaling factor when the capacity threshold is projected to be exceeded. The forecasting system may employ a focus feature engineering technique that gives greater weight to historical data more indicative of future threshold exceedances.

Thus, the forecasting system may conserve computing resources, networking resources, and/or other resources that would have otherwise been consumed by failing to accurately forecast RAN capacity for non-linear KPIs, handling poor end user experience due to failing to accurately forecast RAN capacity, failing to address service degradation in the RAN in a timely manner due to failing to accurately forecast RAN capacity, handling lost traffic due to failing to accurately forecast RAN capacity, and/or the like. The predictive analytics approach of the forecasting system may conserve resources by enabling more accurate capacity planning, leading to a more efficient allocation of such resources. The forecasting system may mitigate the risk associated with both under-provisioning, which could lead to suboptimal RAN performance, and over-provisioning, which could lead to an overly conservative RAN expansion strategy. By accurately identifying a RAN that requires upgrades, the forecasting system may optimize infrastructure improvements and ensure that RAN expansion and resource allocation are based on accurate forecasted data.

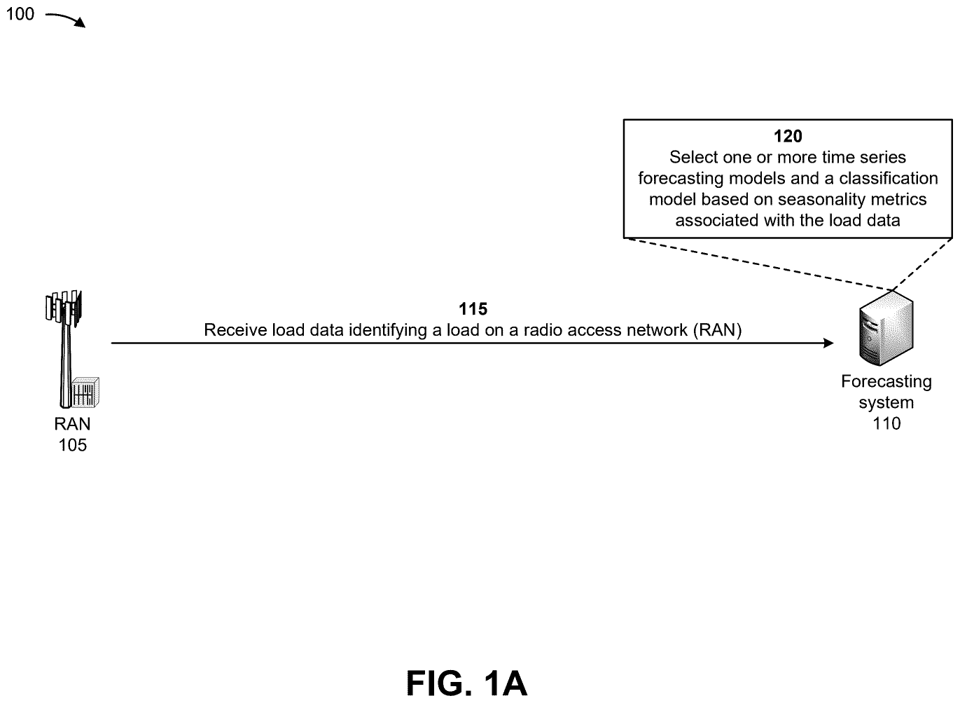

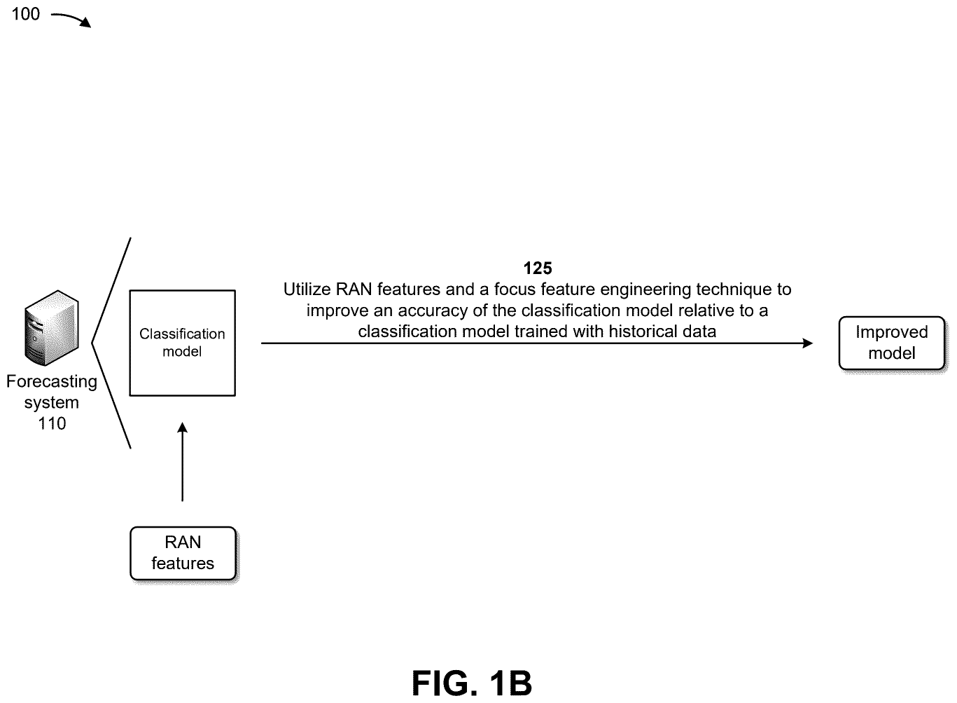

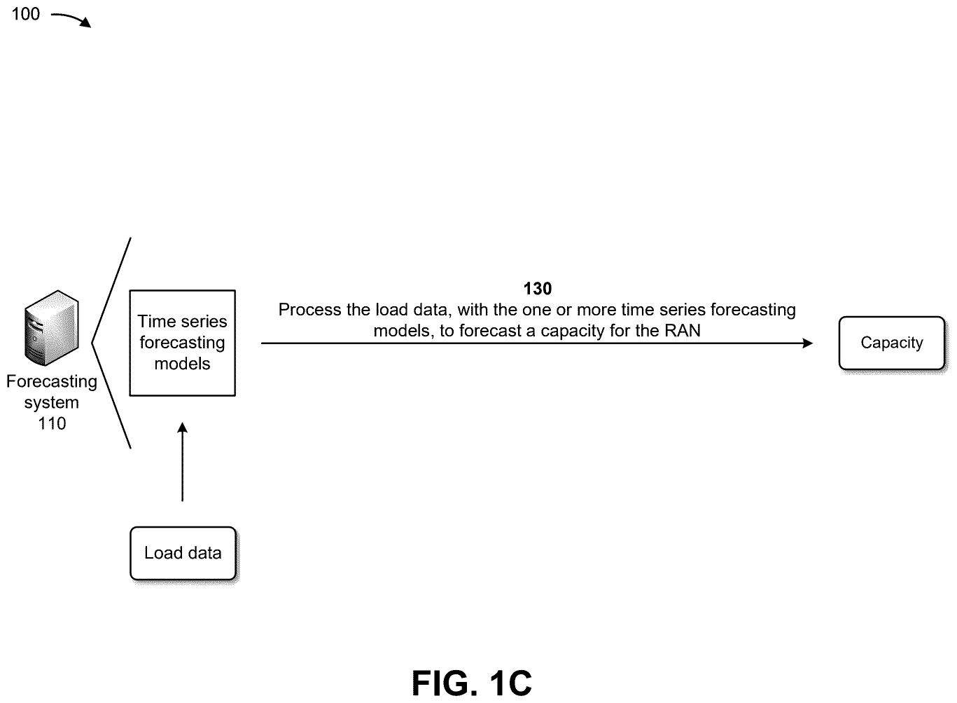

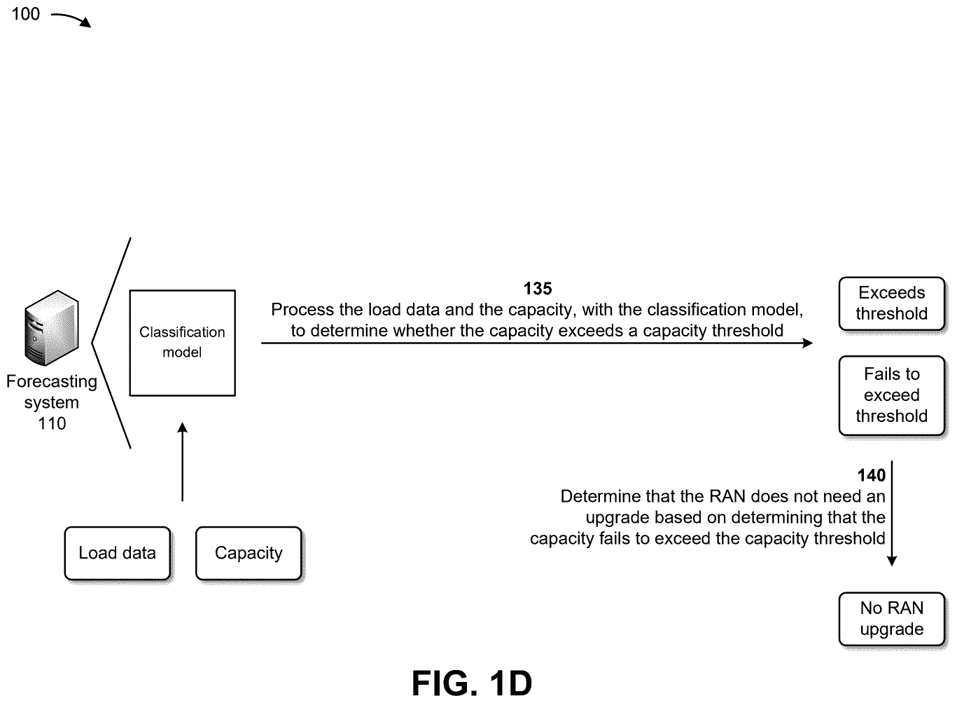

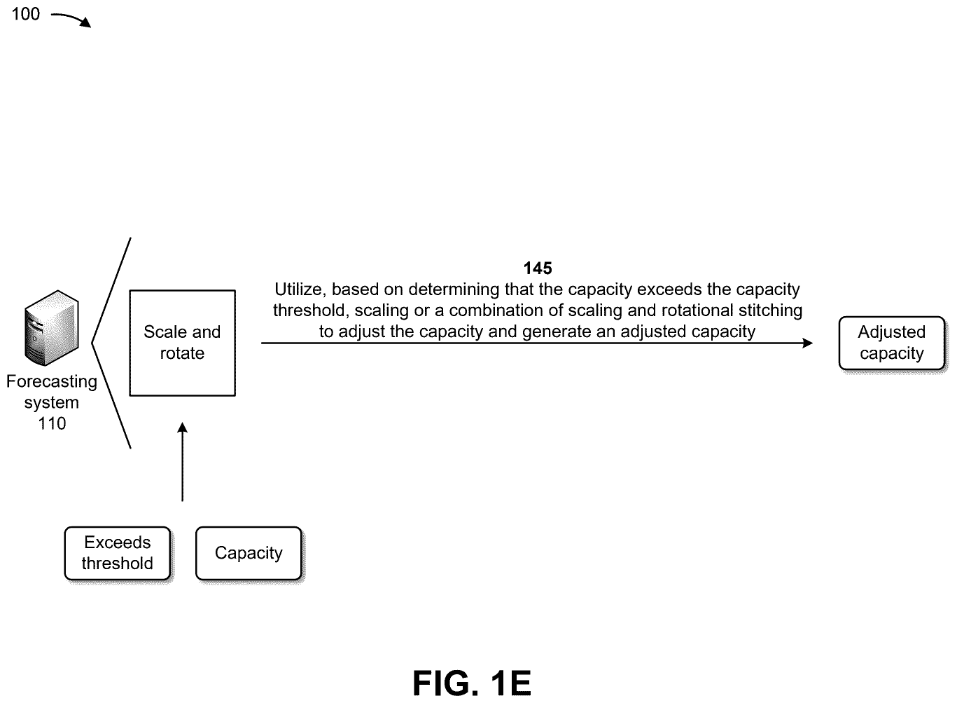

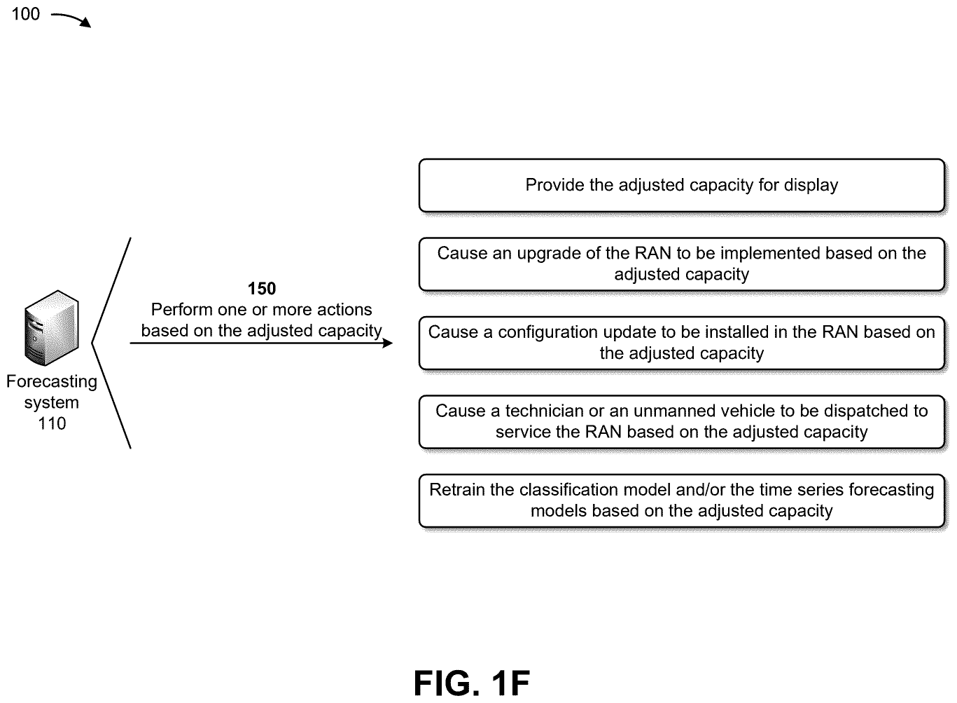

FIGS. 1A-1F are diagrams of an example 100 associated with forecasting time series network capacity. As shown in FIGS. 1A-1F, example 100 includes a RAN 105 associated with a forecasting system 110. Further details of the RAN 105 and the forecasting system 110 are provided elsewhere herein.

As shown in FIG. 1A, and by reference number 115, the forecasting system 110 may receive load data identifying a load on the RAN 105. For example, the RAN 105 may experience a load due to processing traffic received and/or transmitted by the RAN 105. The RAN 105 may generate load data identifying the load on the RAN 105. The forecasting system 110 may periodically receive the load data from the RAN 105, may continuously receive the load data from the RAN 105, may receive the load data from the RAN 105 based on requesting the load data, and/or the like.

In some implementations, the load data may include non-linear time series data and a scheduler metric (e.g., a non-linear KPI). Time series data is a series of data points ordered in time. In a time series, time is often the independent variable, and a goal is usually to make a forecast for the future. Non-linear time series data may include data generated by nonlinear dynamic equations and that displays features that cannot be modeled by linear processes, such as time-changing variance, asymmetric cycles, higher-moment structures, thresholds, and breaks. The scheduler metric provides a measure of the loading of control channels and systems of the RAN 105, and indicates a quantity of users waiting for a service from the RAN 105. The scheduler metric may be utilized to determine whether the RAN 105 needs an upgrade to accommodate the quantity of users. Thus, the load data may provide a measure of the load on the control channels and systems of the RAN 105. The load data may enable the forecasting system 110 to perform a detailed analysis of current usage of the RAN 105 in order to accurately align capacity planning with actual demand, leading to more efficient network management and cost savings.

As further shown in FIG. 1A, and by reference number 120, the forecasting system 110 may select one or more time series forecasting models and a classification model based on seasonality metrics associated with the load data. For example, the forecasting system 110 may be associated with an ensemble of machine learning models, such as time series forecasting models, classification models, and/or the like. The forecasting system 110 may select the one or more of the time series forecasting models and the classification model based on the load data. In some implementations, the selection of the one or more of the time series forecasting models and the classification model may be based on seasonality metrics associated with the load data (e.g., indicating time periods with increased load, such as on work days, or decreased load, such as on weekends) and features associated with the load data (e.g., the scheduler metric, morphology of the RAN 105, frequency bands associated with the RAN 105, carriers present in the RAN 105, a current capacity status of the RAN 105, and/or the like). In some implementations, each of the one or more time series forecasting models may include a Prophet model, which is an open-source tool used for forecasting time series data. In some implementations, the classification model may include an XGBoost model, which is a machine learning model that belongs to the ensemble learning category, specifically the gradient boosting framework. The XGBoost model utilizes decision trees as base learners and employs regularization techniques to enhance model generalization.

As shown in FIG. 1B, and by reference number 125, the forecasting system 110 may utilize RAN features and a focus feature engineering technique to improve an accuracy of the classification model relative to a classification model trained without the RAN features and the focus feature engineering technique. For example, the forecasting system 110 may identify and employ seasonality metrics associated with the load on the RAN 105, as suggested by the RAN features (e.g., the scheduler metric, morphology of the RAN 105, frequency bands associated with the RAN 105, carriers present in the RAN 105, a current capacity status of the RAN 105, and/or the like). In some implementations, the forecasting system 110 may identify and incorporate the busiest time periods within recent history when presenting load data to the classification model, thus enhancing a predictive capability of the classification model. Employing the seasonality metrics may significantly improve an accuracy of the classification model by enabling the classification model to account for periodic changes in RAN load that might otherwise be missed by a model utilizing only historical data. The focus feature engineering technique generates a more refined classification model that can more reliably predict whether the RAN 105 will exceed a capacity threshold at given points in the future, ensuring a sophisticated and accurate capacity planning strategy.

As shown in FIG. 1C, and by reference number 130, the forecasting system 110 may process the load data, with the one or more time series forecasting models, to forecast a capacity for the RAN 105. For example, the forecasting system 110 may utilize the one or more time series forecasting models to forecast a capacity for the RAN 105 based on the load data. In some implementations, the one or more time series forecasting models may analyze historical load data to forecast a capacity for the RAN 105 that extends into future time periods. In some implementations, the forecasting system 110 may utilize various feature engineering techniques, such as the focus feature engineering technique, that enhance the accuracy of the predicted capacity by identifying the most critical historical load data points based on relevance to identified seasonality patterns.

In some implementations, the forecasting system 110 may validate the forecasted capacity against historical capacity exceedance patterns to ensure the accuracy of the forecasted capacity. In some implementations, the one or more time series forecasting models may process the load data to generate multiple KPIs associated with the capacity of the RAN 105, and may utilize the multiple KPIs to refine the forecasted capacity. The forecasting system 110 may retrain the classification model and/or the one or more time series forecasting models based on the refined capacity to further enhance prediction accuracies of the models. By forecasting the capacity requirements for the RAN 105 more accurately, network upgrades can be planned more efficiently, resources can be allocated more effectively, and unnecessary expenditure can be avoided.

As shown in FIG. 1D, and by reference number 135, the forecasting system 110 may process the load data and the capacity, with the classification model, to determine whether the capacity exceeds a capacity threshold. For example, the forecasting system 110 may utilize the classification model to determine whether the capacity exceeds a capacity threshold based on the load data. The capacity threshold may be predetermined (e.g., a percentage threshold) and/or may be dynamically adjusted based on conditions associated with the RAN 105. The classification model may thus provide a trigger indicating whether the capacity is exceeding a capacity threshold (e.g., a yes or no determination). In some implementations, the classification model may determine that the capacity exceeds the capacity threshold. Alternatively, the classification model may determine that the capacity fails to exceed the capacity threshold.

As further shown in FIG. 1D, and by reference number 140, the forecasting system 110 may determine that the RAN 105 does not need an upgrade based on determining that the capacity fails to exceed the capacity threshold. For example, when the classification model determines that the capacity fails to exceed the capacity threshold, the forecasting system 110 may determine that the RAN 105 does not need an upgrade, may scale the capacity of the RAN 105 downwards to reflect the capacity failing to exceed the threshold, and/or the like. In some implementations, if the capacity fails to exceed the capacity threshold, the forecasting system 110 may determine that no additional actions, associated with the RAN 105, are necessary at that time. Utilizing the classification model in conjunction with the seasonality metrics may generate a more precise evaluation of capacity demands of the RAN 105, which may provide operational advantages, such as preventing unnecessary upgrades of the RAN 105 and optimizing resource allocation.

As shown in FIG. 1E, and by reference number 145, the forecasting system 110 may utilize, based on determining that the capacity exceeds the capacity threshold, scaling or a combination of scaling and rotational stitching to adjust the capacity and generate an adjusted capacity. For example, when the classification model determines that the capacity exceeds the capacity threshold, the forecasting system 110 may utilize the scaling or the combination of the scaling and the rotational stitching to adjust the capacity and generate an adjusted capacity. The scaling and rotational stitching techniques may be employed as a precise corrective measure when the forecasted capacity, as determined by the one or more time series forecasting models, exceeds the capacity threshold. Exceeding the capacity threshold may signify potential overload situations that warrant preemptive actions at the RAN 105.

The adjustment of the capacity may include the forecasting system 110 utilizing the scaling technique, which adjusts the forecasted capacity proportionately. Alternatively, or additionally, the forecasting system 110 may utilize the rotational stitching technique, especially in cases where the forecasted capacity indicates a negative growth trend. The rotational stitching technique may include rotating a trajectory of the forecasted capacity to coincide with the capacity threshold, ensuring that the capacity adjustment does not amplify a negative slope, which would be contradictory to capacity expansion. Moreover, applying the scaling or the rotational stitching techniques enables the forecasting system 110 to maintain the integrity of the original forecasted capacity while tailoring the outcome based on insights from the classification model. The scaling and the rotational stitching techniques may bridge the gap between the raw output from the one or more time series forecasting models and the actionable insights needed for expansion or upgrades of the RAN 105. The forecasting system 110 may determine the choice between the scaling or the combination of the scaling and the rotational stitching based on operational data and predictive insights, ensuring a most suitable method is applied for each scenario. This tailored approach significantly enhances the accuracy and reliability of the forecasting process, thereby elevating the overall efficiency of capacity management within the RAN 105.

As shown in FIG. 1F, and by reference number 150, the forecasting system 110 may perform one or more actions based on the adjusted capacity. In some implementations, performing the one or more actions includes the forecasting system 110 providing the adjusted capacity for display. For example, the forecasting system 110 may provide the adjusted capacity to a device associated with a network operator, and the device may display the adjusted capacity to the network operator. This may enable the network operator or automated systems to visualize a current capacity status of the RAN 105 and to make informed decisions regarding network management and upgrades for the RAN 105. In this way, the forecasting system 110 conserves computing resources, networking resources, and/or other resources that would have otherwise been consumed by failing to accurately forecast RAN capacity for non-linear KPIs.

In some implementations, performing the one or more actions includes the forecasting system 110 causing an upgrade of the RAN 105 to be implemented based on the adjusted capacity. For example, the forecasting system 110 may order upgraded components for the RAN 105, and may cause the upgraded components to be installed on the RAN 105. The upgraded components may improve the load-handling capabilities of the RAN 105. This may facilitate proactive maintenance and scaling of the RAN 105 to meet anticipated demand, and may ensuring that the RAN 105 can handle future loads without reaching threshold limits. In this way, the forecasting system 110 conserves computing resources, networking resources, and/or other resources that would have otherwise been consumed by handling poor end user experience due to failing to accurately forecast RAN capacity.

In some implementations, performing the one or more actions includes the forecasting system 110 causing a configuration update to be installed in the RAN 105 based on the adjusted capacity. For example, the forecasting system 110 may generate a configuration update for the RAN 105, and may cause the configuration update to be installed on the RAN 105. The configuration update may cause the RAN 105 to implement functions that manage the adjusted capacity, such as diverting traffic away from the RAN 105, diverting traffic toward the RAN 105, and/or the like. This may optimize performance of the RAN 105 by adjusting settings and parameters in response to the predicted capacity. In this way, the forecasting system 110 conserves computing resources, networking resources, and/or other resources that would have otherwise been consumed by failing to address service degradation in the RAN 105 in a timely manner due to failing to accurately forecast RAN capacity.

In some implementations, performing the one or more actions includes the forecasting system 110 causing a technician or an unmanned vehicle to be dispatched to service the RAN 105 based on the adjusted capacity. For example, the forecasting system 110 may dispatch a technician or an unmanned vehicle to perform maintenance on the RAN 105 or one or more components of the RAN 105, such as replacing a radio of the RAN 105, resetting a radio of the RAN 105, and/or the like. This proactive approach to maintenance can help resolve potential issues before they affect performance of the RAN 105, thereby reducing downtime and improving overall reliability of the RAN 105. In this way, the forecasting system 110 conserves computing resources, networking resources, and/or other resources that would have otherwise been consumed by handling lost traffic due to failing to accurately forecast RAN capacity.

In some implementations, performing the one or more actions includes the forecasting system 110 retraining the classification model and/or the time series forecasting models based on the adjusted capacity. For example, the forecasting system 110 may utilize the adjusted capacity as additional training data for retraining the classification model and/or the time series forecasting models, thereby increasing the quantity of training data available for training the classification model and/or the time series forecasting models. Accordingly, the forecasting system 110 may conserve computing resources associated with identifying, obtaining, and/or generating historical data for training the classification model and/or the time series forecasting models relative to other systems for identifying, obtaining, and/or generating historical data for training machine learning models.

In this way, the forecasting system 110 forecasts time series network capacity. For example, the forecasting system 110 may utilize advanced predictive analytics to enhance accuracy and reliability of capacity forecasting in RAN planning. Specifically, the forecasting system 110 may forecast a time series output based on historical data for one or more capacity metrics. The forecasting system 110 may determine a binary classification output (e.g., indicating whether a capacity threshold is expected to be exceeded) by applying a binary classification model to the time series output and additional features. To ensure the integrity of the forecasting, the forecasting system 110 may adjust the time series output based on the binary classification outcome by applying rotational stitching in cases of discrepancies. Furthermore, the forecasting system 110 may utilize seasonality detection techniques in historical data to identify the most significant data points for the binary classification model, and may utilize a scaling factor when the capacity threshold is projected to be exceeded. The forecasting system 110 may employ a focus feature engineering technique that gives greater weight to historical data more indicative of future threshold exceedances.

Thus, the forecasting system 110 may conserve computing resources, networking resources, and/or other resources that would have otherwise been consumed by failing to accurately forecast RAN capacity for non-linear KPIs, handling poor end user experience due to failing to accurately forecast RAN capacity, failing to address service degradation in the RAN 105 in a timely manner due to failing to accurately forecast RAN capacity, handling lost traffic due to failing to accurately forecast RAN capacity, and/or the like. The predictive analytics approach of the forecasting system 110 may conserve resources by enabling more accurate capacity planning, leading to a more efficient allocation of such resources. The forecasting system 110 may mitigate the risk associated with both under-provisioning, which could lead to suboptimal RAN performance, and over-provisioning, which could lead to an overly conservative RAN expansion strategy. By accurately identifying a RAN 105 that requires upgrades, the forecasting system 110 may optimize infrastructure improvements and ensure that RAN expansion and resource allocation are based on accurate forecasted data.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

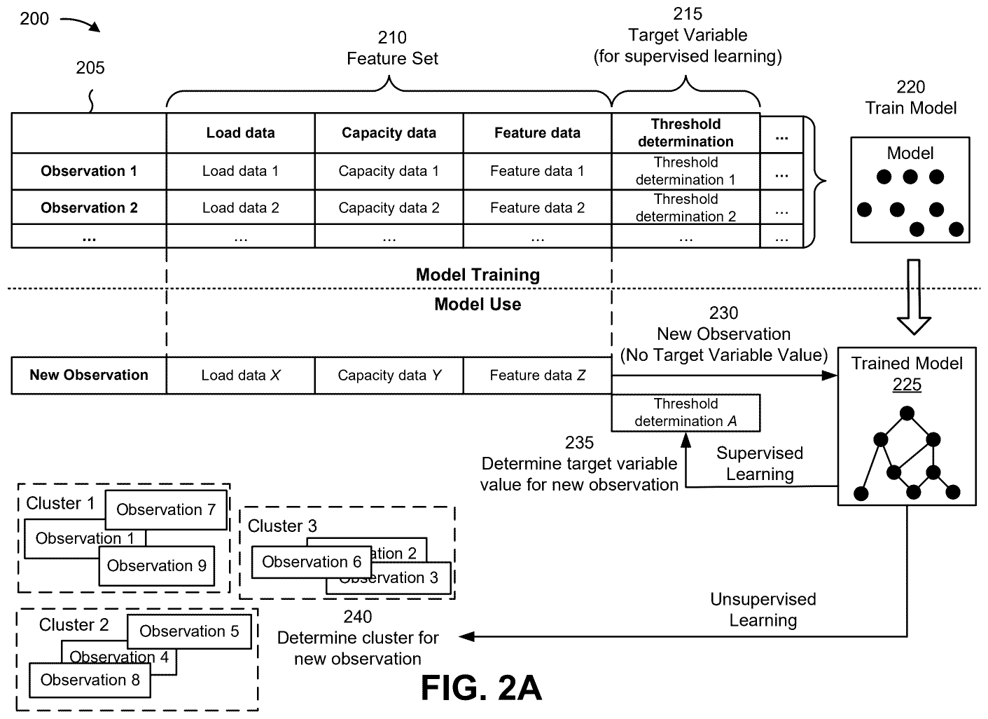

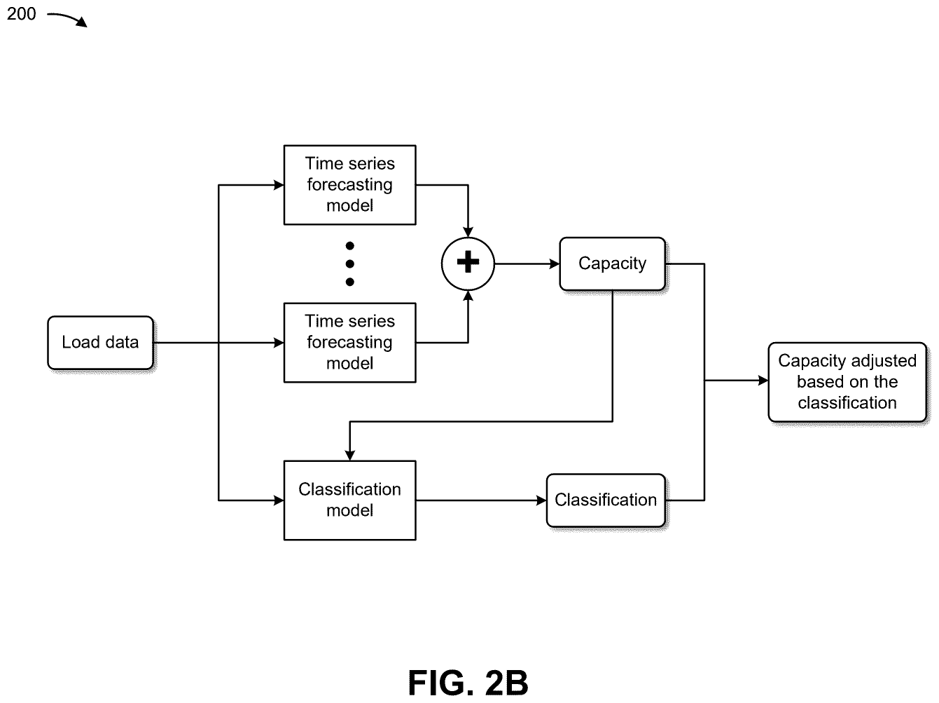

FIGS. 2A and 2B are diagrams illustrating an example 200 of training and using machine learning models for predicting whether a forecasted capacity exceeds a capacity threshold. The machine learning model training and usage described herein may be performed using a machine learning system. The machine learning system may include or may be included in a computing device, a server, a cloud computing environment, and/or the like, such as the forecasting system 110 described in more detail elsewhere herein.

As shown by reference number 205 in FIG. 2A, a machine learning model may be trained using a set of observations. The set of observations may be obtained from historical data, such as data gathered during one or more processes described herein. In some implementations, the machine learning system may receive the set of observations (e.g., as input) from the forecasting system 110, as described elsewhere herein.

As shown by reference number 210 in FIG. 2A, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the forecasting system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of load data, a second feature of capacity data, a third feature of feature data, and so on. As shown, for a first observation, the first feature may have a value of load data 1, the second feature may have a value of capacity data 1, the third feature may have a value of feature data 1, and so on. These features and feature values are provided as examples and may differ in other examples.

As shown by reference number 215 in FIG. 2A, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “threshold determination” and may include a value of threshold determination 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220 in FIG. 2A, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230 in FIG. 2A, the machine learning system may apply the trained machine learning model 225 to a new observation, such as by receiving a new observation and inputting the new observation to the trained machine learning model 225. As shown, the new observation may include a first feature of load data X, a second feature of capacity data Y, a third feature of feature data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of threshold determination A for the target variable of the threshold determination for the new observation, as shown by reference number 235 in FIG. 2A. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240 in FIG. 2A. The observations within a cluster may have a threshold degree of similarity. As an example, if the machine learning system classifies the new observation in a first cluster (e.g., a load data cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a capacity data cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

FIG. 2B depicts an example of an ensemble machine learning model architecture. As shown, the architecture may include the one or more time series forecasting models and the classification model. The one or more time series forecasting models may receive the load data (e.g., or each of the time series forecasting models may receive a portion of the load data) and the classification model may receive the load data. The one or more time series forecasting models may process the load data to generate the capacity, and may provide the capacity to the classification model. The classification model may process the load data and the capacity to generate a classification (e.g., the capacity exceeds a threshold or fails to exceed the threshold). The capacity and the classification may be combined to generate a capacity adjusted based on the classification.

In this way, the machine learning system may apply a rigorous and automated process to predict whether a forecasted capacity exceeds a capacity threshold. The machine learning system enables recognition and/or identification of tens, hundreds, thousands, or millions of features and/or feature values for tens, hundreds, thousands, or millions of observations, thereby increasing accuracy and consistency and reducing delay associated with predicting whether a forecasted capacity exceeds a capacity threshold relative to requiring computing resources to be allocated for tens, hundreds, or thousands of operators to manually predict whether a forecasted capacity exceeds a capacity threshold.

As indicated above, FIGS. 2A and 2B are provided as an example. Other examples may differ from what is described in connection with FIGS. 2A and 2B.

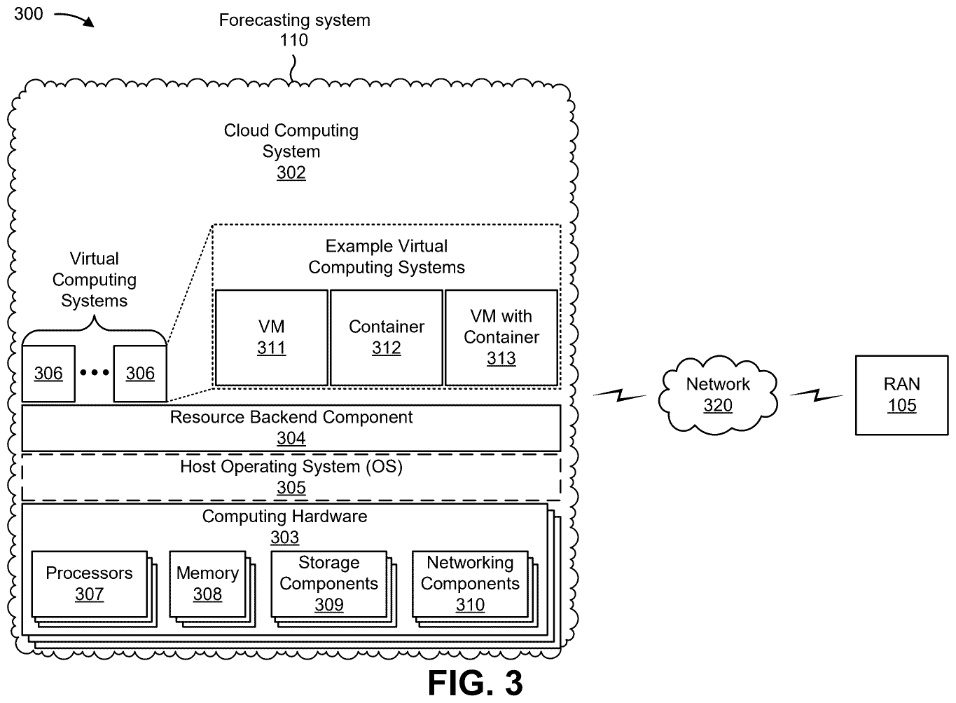

FIG. 3 is a diagram of an example environment 300 in which systems and/or methods described herein may be implemented. As shown in FIG. 3, the environment 300 may include the forecasting system 110, which may include one or more elements of and/or may execute within a cloud computing system 302. The cloud computing system 302 may include one or more elements 303-313, as described in more detail below. As further shown in FIG. 3, the environment 300 may include a RAN 105 and/or a network 320. Devices and/or elements of the environment 300 may interconnect via wired connections and/or wireless connections.

The RAN 105 may support, for example, a cellular radio access technology (RAT). The RAN 105 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for user equipment. The RAN 105 may transfer traffic between a user equipment (e.g., using a cellular RAT), one or more base stations (e.g., using a wireless interface or a backhaul interface, such as a wired backhaul interface), and/or a core network. The RAN 105 may provide one or more cells that cover geographic areas.

In some implementations, the RAN 105 may perform scheduling and/or resource management for a user equipment covered by the RAN 105 (e.g., a user equipment covered by a cell provided by the RAN 105). In some implementations, the RAN 105 may be controlled or coordinated by a network controller, which may perform load balancing, network-level configuration, and/or other operations. The network controller may communicate with the RAN 105 via a wireless or wireline backhaul. In some implementations, the RAN 105 may include a network controller, a self-organizing network (SON) module or component, or a similar module or component. In other words, the RAN 105 may perform network control, scheduling, and/or network management functions (e.g., for uplink, downlink, and/or sidelink communications of user equipment covered by the RAN 105).

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

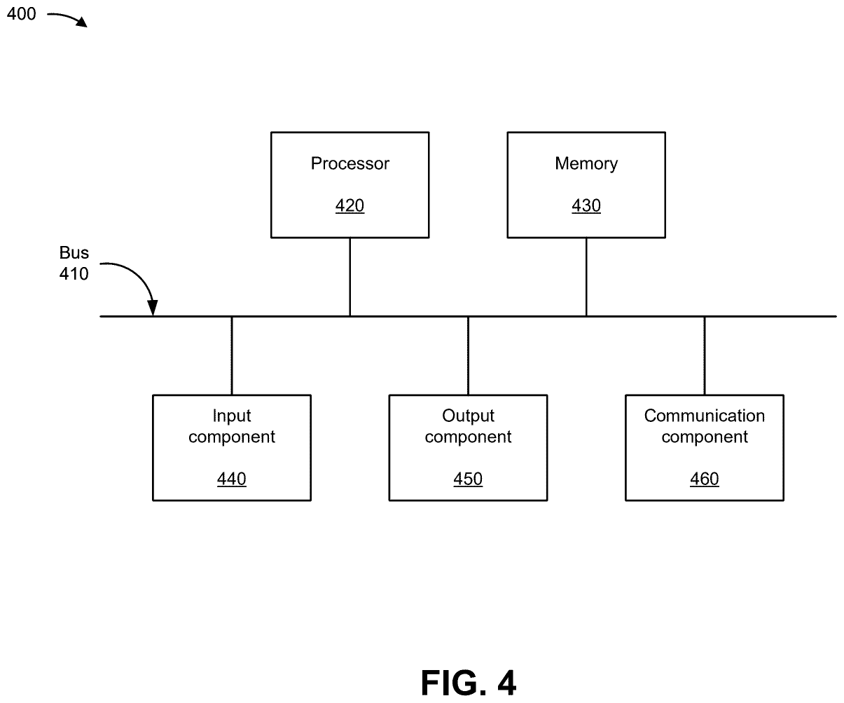

Although the forecasting system 110 may include one or more elements 303-313 of the cloud computing system 302, may execute within the cloud computing system 302, and/or may be hosted within the cloud computing system 302, in some implementations, the forecasting system 110 may not be cloud-based (e.g., may be implemented outside of a cloud computing system) or may be partially cloud-based. For example, the forecasting system 110 may include one or more devices that are not part of the cloud computing system 302, such as the device 400 of FIG. 4, which may include a standalone server or another type of computing device. The forecasting system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the RAN 105 and/or the forecasting system 110. In some implementations, the RAN 105 and/or the forecasting system 110 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

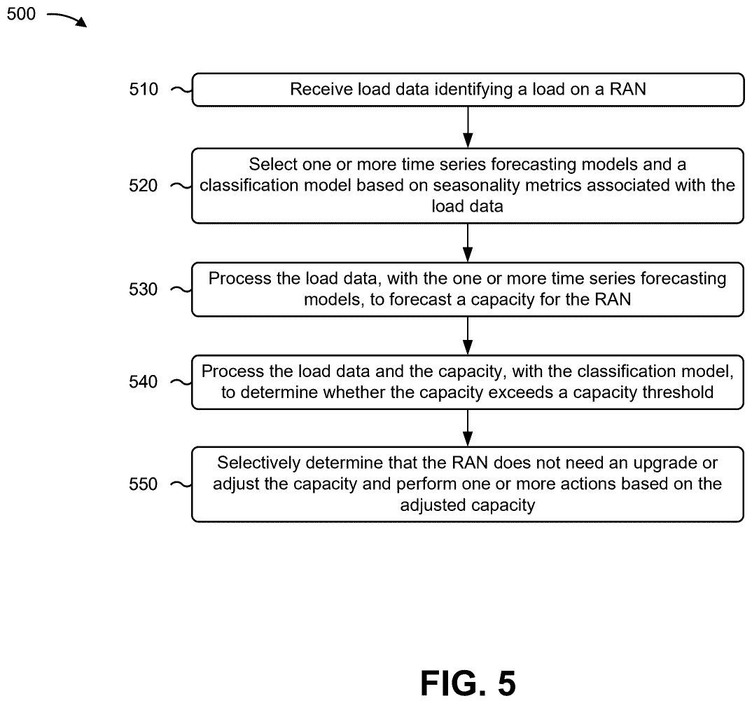

FIG. 5 is a flowchart of an example process 500 for forecasting time series network capacity. In some implementations, one or more process blocks of FIG. 5 may be performed by a device (e.g., the forecasting system 110). In some implementations, one or more process blocks of FIG. 5 may be performed by another device or a group of devices separate from or including the device, such as a RAN (e.g., the RAN 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving load data identifying a load on a RAN (block 510). For example, the device may receive load data identifying a load on a RAN, as described above. In some implementations, the load data includes non-linear time series data. In some implementations, the load data includes a scheduler metric.

As further shown in FIG. 5, process 500 may include selecting one or more time series forecasting models and a classification model based on seasonality metrics associated with the load data (block 520). For example, the device may select one or more time series forecasting models and a classification model based on seasonality metrics associated with the load data, as described above.

As further shown in FIG. 5, process 500 may include processing the load data, with the one or more time series forecasting models, to forecast a capacity for the RAN (block 530). For example, the device may process the load data, with the one or more time series forecasting models, to forecast a capacity for the RAN, as described above. In some implementations, processing the load data, with the one or more time series forecasting models, to forecast the capacity for the RAN includes processing the load data, with the one or more time series forecasting models, to generate a plurality of KPIs associated with the capacity of the RAN, and utilizing the KPIs to refine the capacity forecasted for the RAN.

As further shown in FIG. 5, process 500 may include processing the load data and the capacity, with the classification model, to determine whether the capacity exceeds a capacity threshold (block 540). For example, the device may process the load data and the capacity, with the classification model, to determine whether the capacity exceeds a capacity threshold, as described above.

As further shown in FIG. 5, process 500 may include selectively determining that the RAN does not need an upgrade or adjusting the capacity and performing one or more actions based on the adjusted capacity (block 550). For example, the device may selectively determine that the RAN does not need an upgrade based on determining that the capacity fails to exceed the capacity threshold, or may adjust, based on determining that the capacity exceeds the capacity threshold, the capacity to generate an adjusted capacity, and may perform one or more actions based on the adjusted capacity, as described above.

In some implementations, adjusting the capacity to generate the adjusted capacity includes utilizing scaling or a combination of scaling and rotational stitching to adjust the capacity and generate the adjusted capacity. In some implementations, the rotational stitching limits adjustment of the capacity to a predefined rotational limit. In some implementations, utilizing the scaling includes applying disproportionate scaling to generate the adjusted capacity.

In some implementations, performing the one or more actions includes one or more of providing the adjusted capacity for display, or causing an upgrade of the RAN to be implemented based on the adjusted capacity. In some implementations, performing the one or more actions includes one or more of causing a configuration update to be installed in the RAN based on the adjusted capacity, or causing a technician or an unmanned vehicle to be dispatched to service the RAN based on the adjusted capacity. In some implementations, performing the one or more actions includes retraining the classification model or the time series forecasting models based on the adjusted capacity.

In some implementations, process 500 includes utilizing RAN features and a focus feature engineering technique to improve an accuracy of the classification model relative to a classification model not trained with the RAN features and the focus feature engineering technique. In some implementations, the RAN features include seasonality patterns associated with the load on the RAN. In some implementations, process 500 includes validating the adjusted capacity against historical capacity exceedance patterns of the RAN to ensure accuracy of the adjusted capacity.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, load data identifying a load on a radio access network (RAN);
selecting, by the device, one or more time series forecasting models and a classification model based on seasonality metrics associated with the load data;
processing, by the device, the load data, with the one or more time series forecasting models, to forecast a capacity for the RAN;
processing, by the device, the load data and the capacity, with the classification model, to determine whether the capacity exceeds a capacity threshold; and
selectively:
determining, by the device, that the RAN does not need an upgrade based on determining that the capacity fails to exceed the capacity threshold; or
adjusting, by the device and based on determining that the capacity exceeds the capacity threshold, the capacity to generate an adjusted capacity, and
performing, by the device, one or more actions based on the adjusted capacity.

2. The method of claim 1, further comprising:
utilizing RAN features and a focus feature engineering technique to improve an accuracy of the classification model relative to a classification model not trained with the RAN features and the focus feature engineering technique.

3. The method of claim 2, wherein the RAN features include seasonality patterns associated with the load on the RAN.

4. The method of claim 1, wherein adjusting the capacity to generate the adjusted capacity comprises:
utilizing scaling or a combination of scaling and rotational stitching to adjust the capacity and generate the adjusted capacity.

5. The method of claim 4, wherein the rotational stitching limits adjustment of the capacity to a predefined rotational limit.

6. The method of claim 4, wherein utilizing the scaling includes applying disproportionate scaling to generate the adjusted capacity.

7. The method of claim 1, wherein performing the one or more actions comprises one or more of:
providing the adjusted capacity for display; or
causing an upgrade of the RAN to be implemented based on the adjusted capacity.

8. A device, comprising:
one or more processors configured to:
receive load data identifying a load on a radio access network (RAN);
select one or more time series forecasting models and a classification model based on seasonality metrics associated with the load data;
process the load data, with the one or more time series forecasting models, to forecast a capacity for the RAN;
process the load data and the capacity, with the classification model, to determine whether the capacity exceeds a capacity threshold;
adjust, based on determining that the capacity exceeds the capacity threshold, the capacity to generate an adjusted capacity; and
perform one or more actions based on the adjusted capacity.

9. The device of claim 8, wherein the one or more processors, to perform the one or more actions, are configured to one or more of:
cause a configuration update to be installed in the RAN based on the adjusted capacity; or
cause a technician or an unmanned vehicle to be dispatched to service the RAN based on the adjusted capacity.

10. The device of claim 8, wherein the one or more processors, to perform the one or more actions, are configured to:
retrain the classification model or the time series forecasting models based on the adjusted capacity.

11. The device of claim 8, wherein the load data includes non-linear time series data.

12. The device of claim 8, wherein the load data includes a scheduler metric.

13. The device of claim 8, wherein the one or more processors are further configured to:
validate the adjusted capacity against historical capacity exceedance patterns of the RAN to ensure accuracy of the adjusted capacity.

14. The device of claim 8, wherein the one or more processors, to process the load data, with the one or more time series forecasting models, to forecast the capacity for the RAN, are configured to:
process the load data, with the one or more time series forecasting models, to generate a plurality of key performance indicators (KPIs) associated with the capacity of the RAN; and
utilize the KPIs to refine the capacity forecasted for the RAN.

15. A non-transitory computer-readable medium storing a set of instructions, the set of instructions comprising:
one or more instructions that, when executed by one or more processors of a device, cause the device to:
receive load data identifying a load on a radio access network (RAN),
wherein the load data includes non-linear time series data;
select one or more time series forecasting models and a classification model based on seasonality metrics associated with the load data;
process the load data, with the one or more time series forecasting models, to forecast a capacity for the RAN;
process the load data and the capacity, with the classification model, to determine whether the capacity exceeds a capacity threshold;
adjust, based on determining that the capacity exceeds the capacity threshold, the capacity to generate an adjusted capacity; and
perform one or more actions based on the adjusted capacity.

16. The non-transitory computer-readable medium of claim 15, wherein the one or more instructions further cause the device to:
utilize RAN features and a focus feature engineering technique to improve an accuracy of the classification model relative to a classification model not trained with the RAN features and the focus feature engineering technique,
wherein the RAN features include seasonality patterns associated with the load on the RAN.

17. The non-transitory computer-readable medium of claim 15, wherein the one or more instructions, that cause the device to adjust the capacity to generate the adjusted capacity, cause the device to:
utilize scaling or a combination of scaling and rotational stitching to adjust the capacity and generate the adjusted capacity,
wherein the rotational stitching limits adjustment of the capacity to a predefined rotational limit.

18. The non-transitory computer-readable medium of claim 15, wherein the one or more instructions, that cause the device to perform the one or more actions, cause the device to one or more of:
provide the adjusted capacity for display;
cause an upgrade of the RAN to be implemented based on the adjusted capacity;
cause a configuration update to be installed in the RAN based on the adjusted capacity;
cause a technician or an unmanned vehicle to be dispatched to service the RAN based on the adjusted capacity; or
retrain the classification model or the time series forecasting models based on the adjusted capacity.

19. The non-transitory computer-readable medium of claim 15, wherein the one or more instructions further cause the device to:
validate the adjusted capacity against historical capacity exceedance patterns of the RAN to ensure accuracy in the adjusted capacity.

20. The non-transitory computer-readable medium of claim 15, wherein the one or more instructions, that cause the device to process the load data, with the one or more time series forecasting models, to forecast the capacity for the RAN, cause the device to:
process the load data, with the one or more time series forecasting models, to generate a plurality of key performance indicators (KPIs) associated with the capacity of the RAN; and
utilize the KPIs to refine the capacity forecasted for the RAN.
